(19) United States
(12) Patent Application Publication
(10) Pub. No.: US 2005/0000347 A1
(43) Pub. Date: Jan. 6, 2005

(54) Band saw machine capable of fast replacement of band saw

(76) Inventor: Jung-Hua Lin, Taichung Hsien (TW)

Correspondence Address: BROWDY AND NEIMARK, P.L.L.C.;624 NINTH STREET, NW, SUITE 300, WASHINGTON, DC, 20001-5303, US

(21) Appl. No.: 10/611,912

(22) Filed: Jul. 3, 2003

(51) Int. Cl. B26D 1/46

(52) U.S. Cl. 83/809

(57) ABSTRACT

A band saw machine comprises a base provided with a motor. A driving wheel is pivoted on the base. A movable device is movably provided on the base to be moved between a distal position and a proximal position. A driven wheel is pivoted on the movable device. A band saw is provided around the driving wheel and the driven wheel. A fine adjusting device is engaged with the movable device. A transmission device is movably disposed on the base with an end connected with the fine adjusting device. A cam device is pivoted on the base having a periphery against the transmission device. The cam device is turned between a first position and a second position to move the movable device between the distal position and the proximal position. A handle is connected to the cam device to be operated for turning the cam device.

### BACKGROUND OF THE INVENTION

1. Field of the Invention

The present invention relates generally to a band saw machine, and more particularly to a band saw machine, which is capable of fast replacement of the band saw.

2. Description of the Related Art

A conventional band saw machine is composed of a base, a driving wheel pivoted on a bottom of the base, a driven wheel pivoted on a top of the base and a band saw around the two wheels with a predetermined tension. The band saw runs through a work table fixed on the base. A motor drives the driving wheel to run and the driven wheel and the band saw are driven for running too. A predetermined work piece is put on the work table to be cut by the running band saw. The base is provided with a movable device and a screw bar for driving the movable device sliding. The driven wheel is fixed on the movable device and moves along with it. The driven wheel, therefore, is moved by turning the screw bar to reduce the distance between the driven wheel and the driving wheel such that the band saw is loose to be disengaged from the wheels for replacement. While a new band saw is mounted, the screw bar is turned reversely to tension the band saw.

The way of replacement has to turn the screw bar and it is not an easy job.

### SUMMARY OF THE INVENTION

The primary objective of the present invention is to provide a band saw machine, which is capable of fast replacement of the band saw.

According to the objective of the present invention, a band saw machine comprises a base provided with a motor; a driving wheel pivoted at a bottom of the base to be driven for rotation by the motor; a movable device movably provided on a top of the base to be moved between a distal position and a proximal position; a driven wheel pivoted on the movable device; a band saw provided around the driving wheel and the driven wheel; a fine adjusting device having a section engaged with the movable device and having a contacting portion at a bottom thereof; a transmission device movably disposed on the base and having an end connected with the contacting portion of the fine adjusting device; a cam device pivoted on the base and having a periphery against the transmission device, wherein the periphery of the cam device has an elongate diameter portion and a short diameter portion which a distance between the elongate diameter portion and a center of rotation of the cam device is greater than a distance between the short diameter portion and the center of rotation of the cam device; wherein the cam device is turned between a first position, in which the elongate diameter portion is against the transmission device to move the movable device to the distal position, and a second position, in which the short diameter portion is against the transmission device to move the movable device to the proximal position, and a handle connected to the center of rotation of the cam device to be operated for turning the cam device.

### BRIEF DESCRIPTION OF THE DRAWINGS

FIG. 1 is a front view of a preferred embodiment of the present invention;

FIG. 2 is a lateral view of the preferred embodiment of the present invention, showing the top of the base;

FIG. 3 is a rear view of the preferred embodiment of the present invention, showing the movable device moved to the proximal position, and

FIG. 4 is similar to FIG. 3, showing the movable device moved to the distal position.

### DETAILED DESCRIPTION OF THE INVENTION

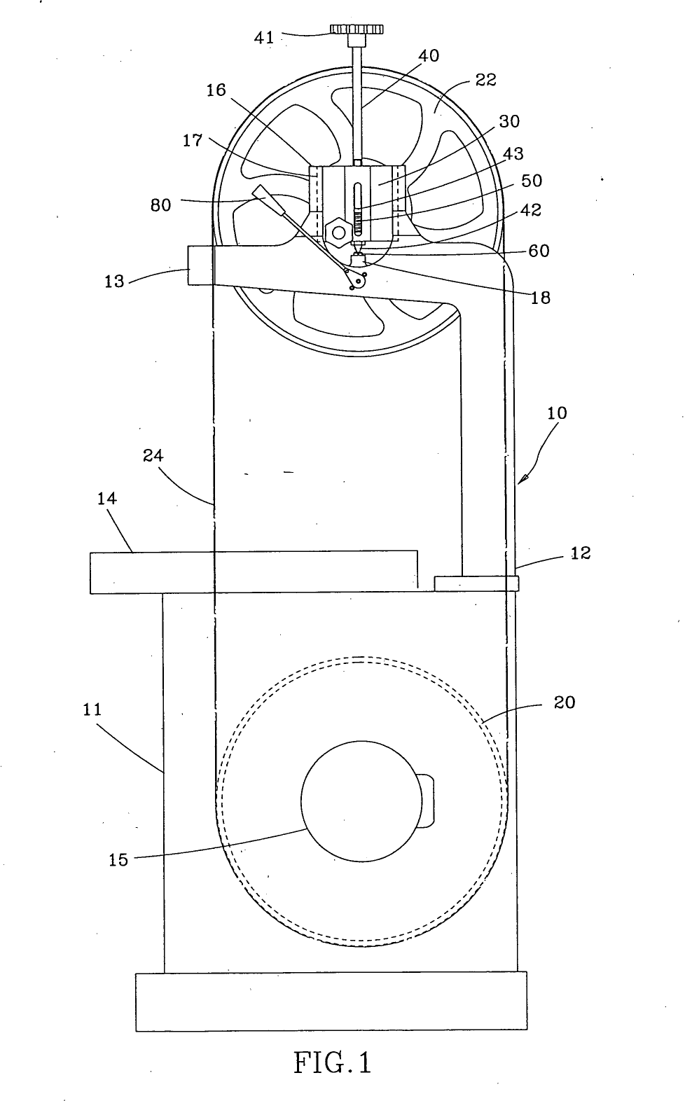

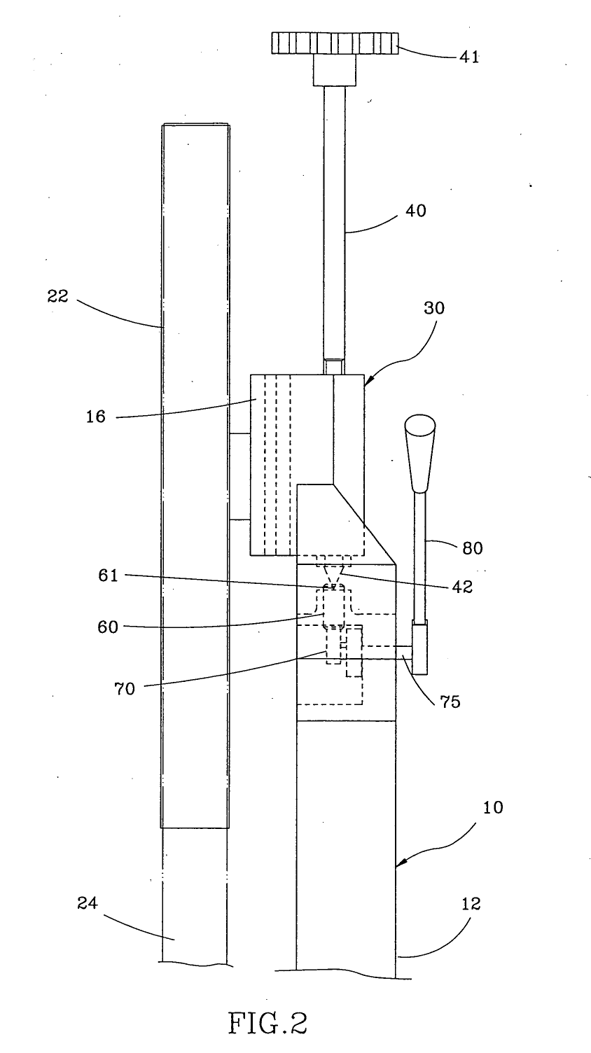

As shown in FIGS. from FIG. 1 to FIG. 3, a band saw machine of the preferred embodiment of the resent invention comprises:

A base 10 is composed of a bottom base 11, a upright frame 12 at a top of the bottom base 11, a top base 13 fixed on a top of the frame 12 and a work table 14 fixed on the bottom base 11. A motor 15 is fixed on the bottom base 11 and the top base 13 has a U-shaped portion 16 with an upward opening at a top thereof. The U-shaped portion 16 has two parallel straight portions in each of which has slot 17 on a sidewall respectively and a round connection tube 18 at a center of a bottom of the U-shaped portion 16. The connection tube 18 runs through the bottom of the U-shaped portion 16.

A driving wheel 20 pivoted on a side of the bottom base 11 of the base 10 and is driven by the motor 15 for rotation.

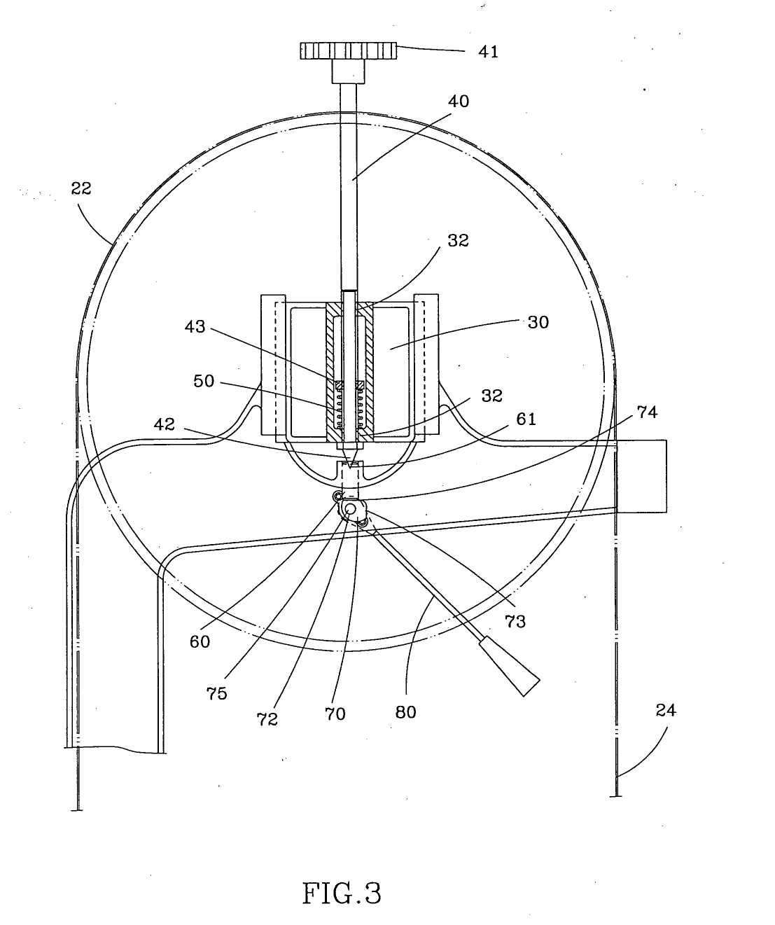

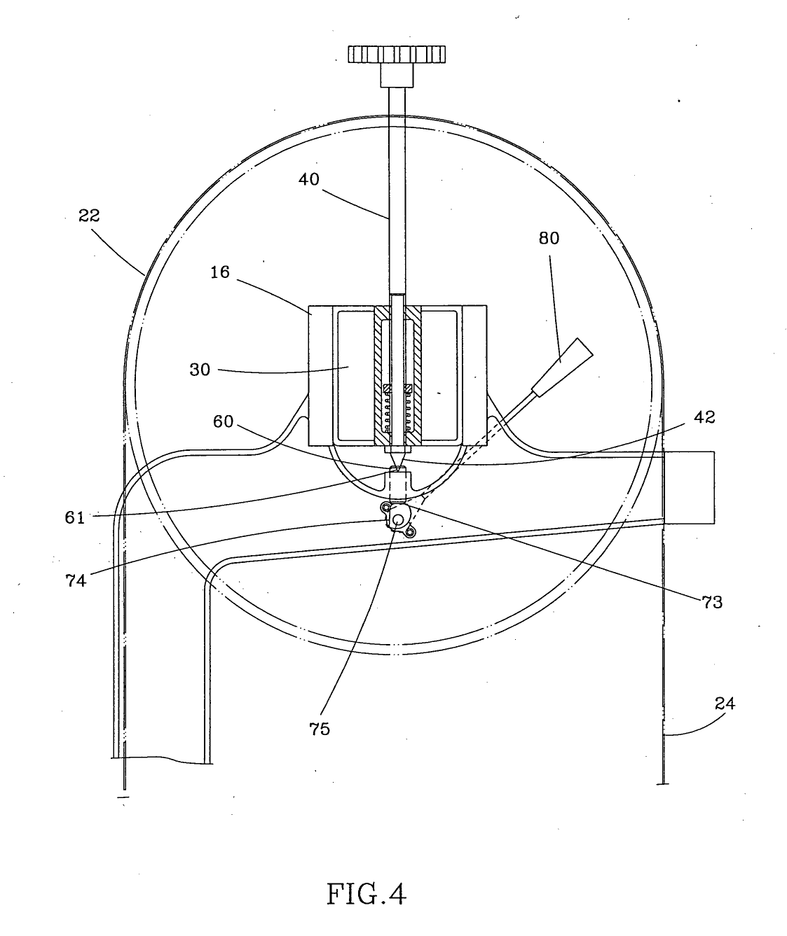

A movable device 30 is a rectangular block in the present invention and is received in the U-shaped portion 16 of the base 10 with opposite ends thereof engaged with the slots 17 respectively. The movable device 30 is moved between a proximal position (shown in FIG. 3) and a distal position (shown in FIG. 4). The movable device 30 has a rectangular chamber 31 along an elongate axis thereof and two thread hole 32 at a top and bottom of the chamber 31 respectively (shown in FIG. 3).

A driven wheel 22 is pivoted on the movable device 30 at a side thereof same with the driving wheel 20. Rotation axes of the driving wheel 20 and the driven wheel 22 are parallel to each other and are coplanarity.

A band saw 24 runs around the driving wheel 20 and the driven wheel 22 and runs through the work table 14.

A fine adjusting device 40 is a screw bar in the present invention which a handle 41 is provided on a top thereof and a cone contacting portion 42 is provided at a bottom thereof. The fine adjusting device 40 is screwed into the thread holes 32 of the movable device 30 and runs through it such that the fine adjusting device 40 has a midsection thereof received the chamber 31, the handle 41 is above the movable device 30 and the contacting portion 42 is below the movable device 30. A nut 43 is engaged with the fine adjusting device 40 and is received in the chamber 31 of the movable device 30.

A compression spring 50 is received in the chamber 31 of the movable device 30 with the fine adjusting device 40 running therethrough. The spring 50 has opposite ends against a bottom sidewall of the chamber 31 and the nut 43.

A transmission device 60, as shown in FIG. 3, is a round column in the present invention. The transmission device 60 is received in the connection tube 18 of the U-shaped portion 16 of the base 10 having a cone slot 61 at an end thereof to rest the contacting portion 42 of the fine adjusting device 40 therein.

A cam device 70 has a predetermined periphery and a hole 72 at an eccentric position so that the cam device 70 has a portion of the periphery distal to the hole 72, which the portion is defined as an elongate diameter portion 73. The periphery of the cam device 70 further has another portion proximal to the hole 72, which the portion is defined as a short diameter portion 74. The cam device 70 is pivoted on the top base 13 by means of a shaft 75 below the U-shaped portion 16 inserted into the hole 72 of the cam device 70 such that the cam device 70 is turned between a first position and a second position. The periphery of the cam device 70 is against a bottom of the transmission device 60. The elongate diameter portion 73 of the cam device 70 is against the transmission device 60 while the cam device 70 is turned to the first position, seeing FIG. 4, and the short diameter portion 74 is against the transmission device 60 while the cam device 70 is turned to the second position.

A handle 80 is an elongate bar in the present invention which an end thereof connected with the shaft 75 to be operated by user for turning the cam device 70.

As shown in FIG. 4, the handle 80 is turned driving the cam device 70 being turned to the first position and the transmission device 60 being moved upwards by the elongate diameter portion 73 and, in the meantime, the movable device 30 is moved to the distal position via the fine adjusting device 40. The distance, now, between the driving wheel 20 and the driven wheel 22 is greater so that the band saw 24 has a predetermined tension and can be driven to run by the motor 15. While an old band saw 24 is needed for replacement, the handle 80 is turned reversely to drive the cam device 70 being turned to the second position from the first position and the transmission device 60 being moved downwards by the short diameter portion 74. The movable device 30 is moved to the proximal position to move the driven wheel 22 toward the driving wheel 20. Such that the band saw 24 is loose for replacement. After replace with a new band saw 24, the handle 80 is turned again to tighten the band saw 24.

The fine adjusting device 40 is turned for fine adjustment of the distance between the driving wheel 20 and the driven wheel 22 so that the tension of the band saw 24 is fine adjusted. The spring 50 firmly secures the fine adjusting device 40 on the movable device 30 to prevent it from being moved in an unexpected condition.

The present invention only needs to turn the handle for replacement of the band saw. The replacement job is easier and faster.

1. A band saw machine, comprising:
a base provided with a motor;
a driving wheel pivoted on a bottom of the base to be driven for rotation by the motor;
a movable device movably provided on a top of the base to be moved between a distal position and a proximal position;
a driven wheel pivoted on the movable device;
a band saw provided around the driving wheel and the driven wheel;
a shaft of a fine adjusting device formed as a unit having a section engaged with the movable device and having a contacting portion at a bottom end thereof;
a transmission device formed as a unit movably disposed on the base and having a top end abutting the bottom end of the contacting portion of the shaft of the fine adjusting device;
a cam device pivoted on the base and having a periphery against the transmission device, wherein the periphery of the cam device has an elongate diameter portion and a short diameter portion which a distance between the elongate diameter portion and a center of rotation of the cam device is greater than a distance between the short diameter portion and the center of rotation of the cam device;
wherein the cam device is turned between a first position, in which the elongate diameter portion abuts against a bottom end of the transmission device to move the movable device up to the distal position, and a second position, in which the short diameter portion abuts against the bottom end of the transmission device to move the movable device down to the proximal position,
a handle connected to the center of rotation of the cam device to be operated for turning the cam device; and
wherein the transmission device is located between the fine adjusting device and the cam device.

2. The band saw machine as defined in claim 1, wherein the top of the base is provided with a U-shaped portion with an upward opening on a top thereof, wherein the U-shaped portion has two parallel straight portions in each of which has a slot on a sidewall thereof so that the movable device is slidably received in the U-shaped portion.

3. The band saw machine as defined in claim 2, wherein the U-shaped portion is provided with a round connection tube at a center of a bottom thereof and the connection tube runs through the bottom of the U-shaped portion and the transmission device is slidably received in the connection tube.

4. The band saw machine as defined in claim 3, wherein the movable device has a chamber which a top and a bottom thereof is provided with a thread hole respectively and the fine adjusting device is engaged with the thread holes and has a portion received in the chamber and the contacting portion of the fine adjusting device is extruded out of the movable base to be connected with the transmission device.

5. The band saw machine as defined in claim 4, wherein the transmission device has a cone recess and the contacting portion of the fine adjusting device is a cone to be rested in the recess.

6. The band saw machine as defined in claim 4, wherein the fine adjusting device has a thread section received in the chamber of the movable device with which a nut is engaged and a spring is received in the chamber with the fine adjusting device running therethrough, wherein the spring has opposite ends thereof against the nut and a sidewall of the chamber respectively.
